(19) United States
(12) Patent Application Publication
(10) Pub. No.: US 2011/0207578 A1
(43) Pub. Date: Aug. 25, 2011

(54) Harmonic Gear Multi-Turn Encoder

(75) Inventors: Sze Kuang Lee, Bayan Lepas (MY); Weng Fei Wong, Gelugor (MY)

(73) Assignee: Avago Technologies ECBU (Singapore) Pte, Ltd., Fort Collins, CO (US)

(21) Appl. No.: 12/710,494

(22) Filed: Feb. 23, 2010

(51) Int. Cl. B60W 10/10

(52) U.S. Cl. 477/34

(57) ABSTRACT

Various embodiments of harmonic gear multi-turn encoders are disclosed that provide the ability to accurately sense absolute rotational positions over a wide range of rotational counts. High gear reduction ratios in each stage of the multi-turn encoders permit very small size and volume encoders to be provided, thereby opening up many new applications for multi-turn encoders. In one embodiment, inductive means are employed to determine the number of revolutions a central shaft operably connected to an encoder module has turned. The inductive coils comprise emitter coils and receiver coils, which are operably associated with and opposed to corresponding encoder devices. The various embodiments of the harmonic gear multi-turn encoders disclosed herein are capable of operating under high temperature conditions and withstanding the effects of various environmental contaminants, and are also amenable to miniaturization and low cost manufacturing.

### FIELD OF THE INVENTION

Various embodiments of the invention described herein relate to the field of encoders, and components, devices, systems and methods associated therewith.

### BACKGROUND

Multi-turn optical encoders are employed in many different applications. The mechanical construction of multi-turn optical encoders is normally based on gear train design, where gears with openings or holes must be provided for light to pass through the gears for subsequent collimation, reflection or detection. The openings or holes often prevent the gears in optical encoders from being packed very close to one another, and also reduce the precision that may be obtained for injection-molded gears. In addition, substrates such as printed circuit boards, flexible cables and the like are typically required on both sides of the gear train to impart the required mechanical integrity to such optical encoders. Finally, multi-turn optical encoders are typically incapable of sensing partial revolutions of the constituent disks contained therein.

Magnetic multi-turn encoders are also known in the art, but are easily affected by external magnetic fields and cannot operate at very high temperatures without being demagnetized. Such characteristics obviously limit the type and number of applications in which magnetic multi-turn encoders may be used.

Finally, intense pressure and motivation exists to miniaturize encoders multi-turn encoders so that they have smaller footprints, occupy less space, and can be used in ever smaller devices and applications.

What is needed is a multi-turn encoder that may be made more compact, manufactured at lower cost, operate at higher precision, and permit partial revolutions of constituent disks to be sensed and measured.

### SUMMARY

In some embodiments, there is provided a multi-turn encoder module having a first stage comprising a first rotatable wave generator comprising a first input shaft, a first flexible spline operably coupled to at least a portion of the first wave generator, the first flexible spline having a first number of geared teeth disposed about a first outer periphery thereof, a first encoding device attached to the first flexible spline, a first circular spline configured to receive and engage at least a portion of the first outer periphery of the first flexible spline in a first inner periphery thereof, the first circular spline having a second number of geared teeth disposed about the first inner periphery, the first number of teeth being less than the second number of teeth, and a first sensing element configured to sense rotation of the first encoding device in respect thereof, wherein a first gearing reduction ratio of the first stage equals (the first number of teeth−the second number of teeth)/(the first number of teeth).

In other embodiments, there is provided a method of determining a number of revolutions a shaft in a multi-turn encoder has turned comprising providing a first stage of the encoder comprising a first rotatable wave generator comprising a first input shaft, a first flexible spline operably coupled to at least a portion of the first wave generator, the first flexible spline having a first number of geared teeth disposed about a first outer periphery thereof, a first encoding device attached to the first flexible spline, a first circular spline configured to receive and engage at least a portion of the first outer periphery of the first flexible spline in a first inner periphery thereof, the first circular spline having a second number of geared teeth disposed about the first inner periphery, the first number of teeth being less than the second number of teeth, and a first sensing element configured to sense rotation of the first encoding device in respect thereof, wherein a first gearing reduction ratio of the first stage equals (the first number of teeth−the second number of teeth)/(the first number of teeth), rotating the first shaft of the first wave generator and thereby causing the first flexible spline and the first circular spline to rotate with respect to one another according to the first gear reduction ratio, and generating, with the first sensing element, an output signal representative of a revolution of the first flexible spline and the first encoding device corresponding thereto thereby to permit a number of revolutions the shaft has rotated to be determined by a position logic device.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a top perspective view of one embodiment of a first stage of a harmonic gear multi-turn encoder;

FIG. 2 shows a top perspective view of one embodiment of first and second stages of a harmonic gear multi-turn encoder;

FIG. 3 shows a cross-sectional view of the harmonic gear multi-turn encoder of FIG. 2;

FIG. 4 shows one embodiment of a sensing element;

FIG. 5 shows one embodiment of a flexible spline and encoder device in conjunction with a corresponding sensing element;

FIG. 6 shows one embodiment of an inductive coil;

FIG. 7 shows a schematic electrical diagram of one embodiment of a coil emitter and a coil receiver;

FIGS. 8 and 9 shows representative modulated and demodulated outputs provided according to one embodiment, and

FIG. 10 shows one embodiment of a block diagram of an inductive multi-turn encoder of the invention.

The drawings are not necessarily to scale. Like numbers refer to like parts or steps throughout the drawings, unless otherwise noted.

### DETAILED DESCRIPTIONS OF SOME PREFERRED EMBODIMENTS

Harmonic or strain wave gearing was introduced conceptually by C. W. Musser in 1957, and is the subject of numerous printed publications, including, but not limited to, U.S. Pat. No. 2,906,1453 to Musser entitled “Strain Wave Gearing,” U.S. Pat. No. 6,258,007 to Kristjansson entitled “Multi-Sensor Harmonic Drive Actuator Arrangement Assembly,” U.S. Patent Publication No. 2004/0177718 A1 to Poehlau entitled “Harmonic Drive,” U.S. Patent Publication No. 2007/0281824 A1 to Tezuka et al. entitled “Reduction Gear Unit with Rotational Position Sensor,” U.S. Patent Publication No. 2008/0047511 A1 to Taye et al. entitled “Harmonic Drive Camshaft Phaser,” and “Torque ripple and misalignment torque compensation for the built-in torque sensor of harmonic drive systems” to Taghirad and Belanger, Instrumentation and Measurement, IEEE Transactions, Vol. 47, Issue 1, February, 1998, pages 309-315. See also a publication entitled “Spur Gears,” which is to be found on the website roymech.co.uk/Useful_Tables/Drive/Gears.htm, a copy of which is submitted in conjunction with an Information Disclosure Statement filed on even date herewith. Each of the foregoing publications, including the foregoing “Spur Gears” publication, is hereby incorporated by reference herein, each in its respective entirety.

Harmonic gearing possesses several notable advantages, including the ability to provide compact, lightweight gear drive systems with high gear reduction ratios. The function of a harmonic drive is based on a rotating wave generator radially deforming an inner hoop of a flexible spline while revolving, and pushes the inner hoop with its outer casing surface along a surrounding sector locally outward against a hollow cylindrical inner surface of a stationary circular spline fixed on a housing, where the inner surface has a slightly larger circumference. Thus, the flexible spline rolls over the gear-tooth system in the circular spline with a positive fit. The flexible spline rotates slower than the input shaft of the wave generator depending on the amount of the circumferential difference between the flexible spline and the circular spline. The result is greatly reduced rotation of the flexible spline compared to the amount of rotation provided by the input shaft of the wave generator.

Harmonic gear mechanisms have three basic components: a wave generator, a flexible spline, and a circular spline. More complicated harmonic gear mechanisms may include additional components. At its proximal end the wave generator has an input shaft through which rotational motion is imparted to the overall gear mechanism. At its distal end the wave generator features one or more cams or other mechanical devices which are configured to engage and deform the inner periphery of the flexible spline. The flexible spline may be configured like a shallow cup, where the sides of the flexible spline are relatively thin, but the bottom of the flexible spline is thick and rigid. This results in significant flexibility of the walls of the flexible spline at its open end due to the thin walls, but in the closed side being quite rigid and able to be tightly secured to a shaft, for example. Teeth are positioned radially around an outside periphery of the flexible spline. The flexible spline fits tightly over the distal end of the wave generator such that when the input shaft of the wave generator is rotated, the flexible spline deforms but does not rotate in step with the wave generator.

In one embodiment, the circular spline is a rigid circular ring with teeth on the inside. The flexible spline and the wave generator are placed inside the circular spline, meshing the teeth of the flexible spline and the circular spline. Because the flexible spline can assume a non-circular or elliptical shape, its teeth mesh with the teeth of the circular spline over only two opposing regions of the flexible spline. The wave generator provides input rotational movement to the harmonic gear system. As the wave generator rotates, the teeth of the flexible spline meshing with those of the circular spline change. The major axis of the flexible spline rotates with the wave generator so that the points where the teeth of the flexible spline and the circular spline mesh revolve around a center point at the same rate at which the wave generator rotates. In a harmonic drive there are fewer teeth on the flexible spline than on the circular spline (say two teeth fewer). This means that for every full rotation of the input shaft of the wave generator, the flexible spline rotates only a slight amount backward with respect to the circular spline. Thus, rotation of the wave generator results in a much slower rotation of the flexible spline in the opposite direction.

In a harmonic drive, the gearing reduction ratio can be calculated from the number of teeth included on the flexible spline and the circular spline as follows:

$$Gearing reduction ratio = \frac{( \begin{matrix}number of flexible spline teeth - \\ number of circular spline teeth\end{matrix} )}{( number of flexible spline teeth )} \qquad eq . ( 1 )$$

For example, if there are 102 teeth on the circular spline and 100 teeth on the flexible spline, the reduction ratio is: (100−102)/100=−0.02. Thus, the flexible spline spins at 2/100 the speed of the wave generator and in the opposite direction. This allows different reduction ratios to be provided by the harmonic drive without changing the shape of the harmonic drive mechanism, increasing its weight, or adding stages. The range of possible gear ratios in a given stage is limited by tooth size limits available for a given configuration.

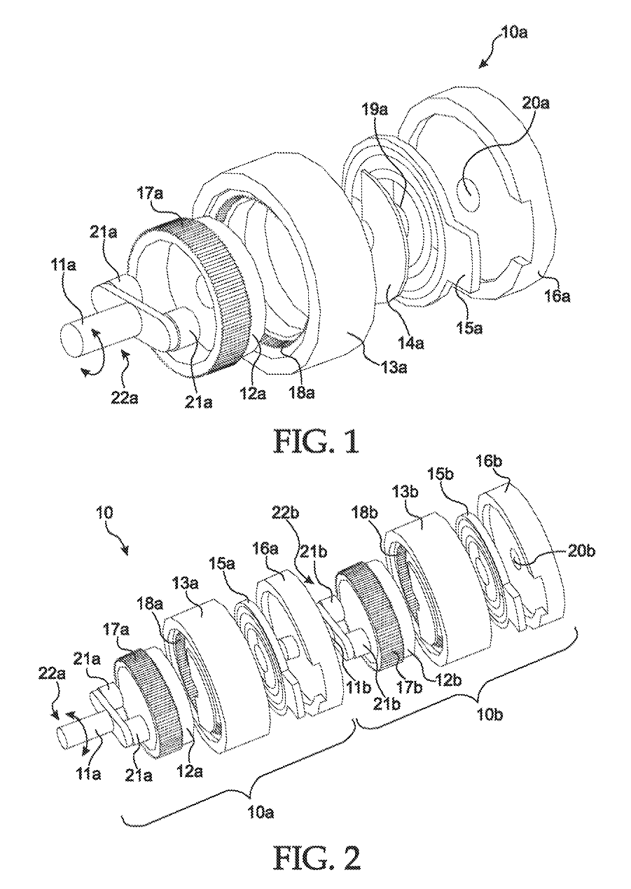

FIG. 1 shows one embodiment of a first or single stage 10a of a harmonic gear multi-turn encoder, which as shown comprises a first rotatable wave generator 22a comprising a first input shaft 11a, and a first flexible spline 12a operably coupled to at least a portion of the first wave generator 22a. The first flexible spline 12a has a first number of geared teeth 17a disposed about a first outer periphery thereof, a first encoding device 14a attached to the first flexible spline 12a, a first circular spline 13a configured to receive and engage at least a portion of the first outer periphery of the first flexible spline 12a in a first inner periphery thereof, the first circular spline 13a having a second number of geared teeth 18a disposed about the first inner periphery. The first number of teeth is less than the second number of teeth. In the embodiment of FIG. 1, a first sensing element 15a comprises a first plurality of inductive coils configured to sense rotation of the first encoding device 14a in respect thereof.

A first gearing reduction ratio of the first stage equals:

$$\frac{( first number of teeth - second number of teeth )}{first number of teeth} \qquad eq . ( 2 )$$

FIG. 2 shows a top perspective view of one embodiment of a multi-stage harmonic gear multi-turn encoder comprising first stage 10a and second stage 10b. In one embodiment, and as shown in FIG. 2, first stage 10a comprises the same components described above with respect to FIG. 1, while second stage 10b comprises second rotatable wave generator 22b comprising a second input shaft 11b, and a second flexible spline 12b operably coupled to at least a portion of the second wave generator 22b. The second flexible spline 12b has a third number of geared teeth 17b disposed about a second outer periphery thereof, a second encoding device 14b attached to the second flexible spline 12b, a second circular spline 13b configured to receive and engage at least a portion of the second outer periphery of the second flexible spline 12b in a second inner periphery thereof, the second circular spline 13b having a fourth number of geared teeth 18b disposed about the second inner periphery. The third number of teeth is less than the fourth number of teeth. In the embodiment of FIG. 2, a second sensing element 15b comprises a second plurality of inductive coils configured to sense rotation of the second encoding device 14b in respect thereof.

A second gearing reduction ratio of the second stage equals:

$$\frac{( third number of teeth - fourth number of teeth )}{( third number of teeth )} \qquad eq . ( 3 )$$

The embodiment shown in FIG. 2 therefore provides an overall gearing reduction ratio that is a product of the first gearing reduction ratio and the second gearing reduction ratio.

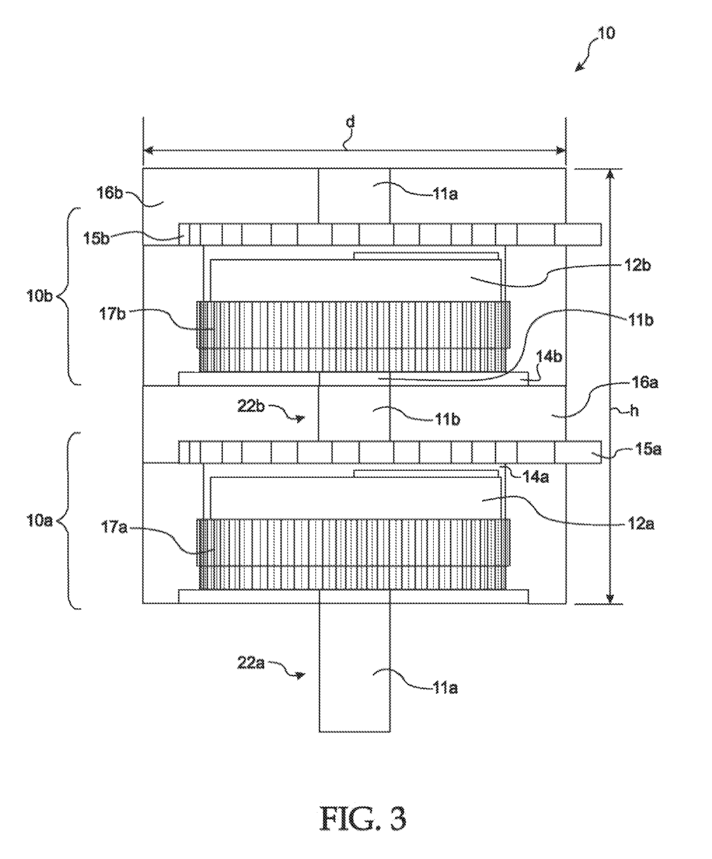

FIG. 3 shows a side cross-sectional view of two stages 10a and 10b of FIG. 2 assembled together to form an operational multi-turn encoder 10. As will be seen, multi-turn encoder 10 of FIG. 3 has very compact dimensions and occupies a very small volume, making it suitable for use in applications where small size and volume are required in a multi-turn encoder capable of providing high gear reduction ratios. For example, and referring to the embodiments illustrated in FIGS. 2 and 3, first stage 10a has 128 teeth on the outer periphery 17a of flexible spline 12a, 130 teeth on the inner periphery of circular spline 18a, a resulting gear ratio of 64, a circular spline pitch diameter of 13 mm, and is capable of providing six bits of resolution. Second stage 10b also has 128 teeth on the outer periphery 17b of flexible spline 12b, 130 teeth on the inner periphery of circular spline 18b, a module of 0.10, a resulting gear ratio of 64, a circular spline pitch diameter of 13 mm, and is also capable of providing six bits of resolution.

Note that the term “module” (or the quantity “m”) as employed herein may be derived by dividing pitch circle diameter in mm by the number of teeth on a gear. Alternatively, the term “diametric pitch” (or the quantity “dₚ”) may be employed, which is the number of teeth on a gear divided by diametrical pitch in inches. For further information regarding the quantities “m” and “dₚ”, see the publication “Spur Gears” referenced above.

The overall width d of encoder 10 shown in FIG. 3 is about 15 mm, while the overall height h is about 6 mm. Thus, multi-turn encoder 10 of FIGS. 2 and 3 is capable of providing an overall gear reduction ratio of 64×64=4,096, or 12 bits of resolution. In other words, dual-stage multi-turn encoder 10 of FIGS. 2 and 3 is capable of recording or measuring 4,096 revolutions of input shaft 11a before being reset back to zero.

Embodiments of multi-turn encoder 10 other than those shown in FIGS. 1, 2 and 3 are also contemplated, which may have more or fewer gears, more or fewer stages, more or fewer bits, greater or lesser gear reduction ratios, and greater or lesser widths d or heights h. See Table 1, below, for example, where design details for some different embodiments of multi-turn encoder 10 are presented.

TABLE 1
Examples of Harmonic Gear Multi-Turn Encoders

| Harmonic Gear | | | | | |
|---|---|---|---|---|---|
| Multi-Turn Encoder | De- | De- | De- | De- | De- |
| Characteristics | sign 1 | sign 2 | sign 3 | sign 4 | sign 5 |
| Number of bits | 6 | 10 | 12 | 14 | 15 |
| No. of stages | 1 | 2 | 2 | 2 | 3 |
| Gear reduction | 64 | 32 | 64 | 128 | 32 |
| ratio per stage | | | | | |
| No. of flexible | 128 | 64 | 128 | 256 | 64 |
| spline teeth | | | | | |
| No. of circular | 130 | 66 | 130 | 258 | 66 |
| spline teeth | | | | | |
| Gear module | 0.1 | 0.1 | 0.1 | 0.1 | 0.1 |
| Circular spline | 13 | 6.6 | 13 | 25.8 | 6.6 |
| pitch (mm) | | | | | |
| Circular spline outer | 15 | 8.6 | 15 | 27.8 | 8.6 |
| diameter d (mm) | | | | | |
| Overall height h | 3.1 | 6.2 | 6.2 | 6.2 | 9.3 |
| (mm) | | | | | |

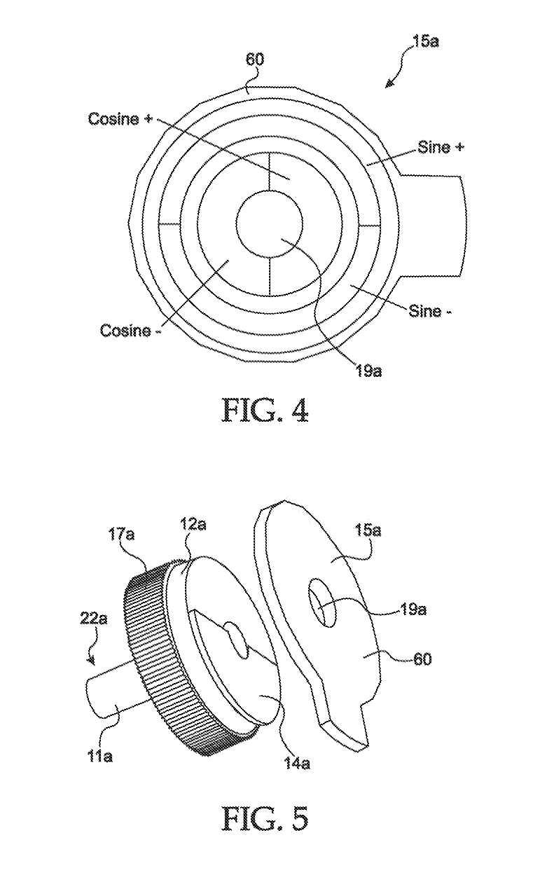

Continuing to refer to FIGS. 1, 2 and 3, and also referring now to FIGS. 4 and 5, it will be seen that stages 10a and 10b include encoder devices 14a and 14b, and inductive sensing elements 15a and 15b. Sensing elements 15a and 15b detect the absolute position of flexible splines 17a and 17b, where pairs of sine and cosine half-circle-shaped inductive coils are disposed on substrates of sensing elements 15a and 15b (see FIG. 4). As shown in FIGS. 4 and 5, sensing element 15a has a plurality of sets of inductive sine and cosine coils disposed thereon or therein, where each of the inductive coils is operably aligned and configured in respect of a corresponding opposing encoder device 14a, which in the embodiments shown in FIGS. 1 through 5 is a half-circle-shaped device formed of an electrically conductive material such as a metal or metal alloy. A position logic device (not shown) is configured to determine a rotational parameter of input shaft 11a on the basis of the relative positions of encoder device 14a and sensing element 15a respecting one another as they are sensed by the inductive coils disposed on or in sensing element 15a.

Each of the inductive sine and cosine coils is configured to generate an output signal representative of a revolution of the corresponding flexible spline operably aligned in respect thereof and opposed thereto, which permits a number of revolutions shaft 11a has rotated to be determined by the position logic device, which may be any suitable processing or logic device, such as a controller, ASIC, processor, micro-processor, micro-controller, CPU, or any combination of appropriate logic hardware and/or software.

Depending on the particular application at hand, and as discussed above, multi-turn encoder module 10 may be configured to provide any of a number of different desired gear reduction ratios in respect of the rotation of shaft 11a and the rotation of the last flexible spline caused to be rotated by the action of shaft 11a rotating, including, but not limited to gear reduction ratios of 8,198; 4,096; 2,048; 1,024; 512, 256, 128, 64, 32, 16, 8, 4, 2 or any other suitable gear reduction ratio, and the respective numbers of bits corresponding thereto (e.g., 32, 24, 18, 12, 6, etc., or any other suitable number of bits). Implementation of a selected gear reduction ratio requires appropriate design and selection of the flexible splines, circular splines, and other components and factors well known to those skilled in the art of gear reduction. See, for example, Table 1 above. Similarly, the first, second, third and fourth numbers of teeth may be varied so as to, for example, exceed 4, 8, 16, 32, or 64, range between 64 and 512, or range between 65 and 514, and so on.

Electrically conductive encoder devices 14a and 14b may comprise at least one of metal, metal foil, an electrically conductive polymer, an electrically conductive plastic, a metal alloy, a combination of metals, or any other suitable electrically conductive material. As those skilled in the art will understand, however, for most applications metal or metal alloys are preferred materials.

The sine and cosine inductive coils of sensing elements 15a and 15b may be integrated into their corresponding substrates, or positioned or disposed thereatop or therebelow. Such inductive coils may further form separate components attached to their respective substrates. Moreover, these inductive coils may comprise emitter or transmitter coils, and receiver coils. For example, each of the inductive sine and cosine coils of FIG. 4 may comprise one pair of emitter coils and two pairs of receiver coils. By way of example, the receiver coils may be configured to be 90 degrees out of phase with respect to one another. Other phase differences between received signals may also be employed, including, but not limited to, 30 degrees, 45 degrees, and 60 degrees.

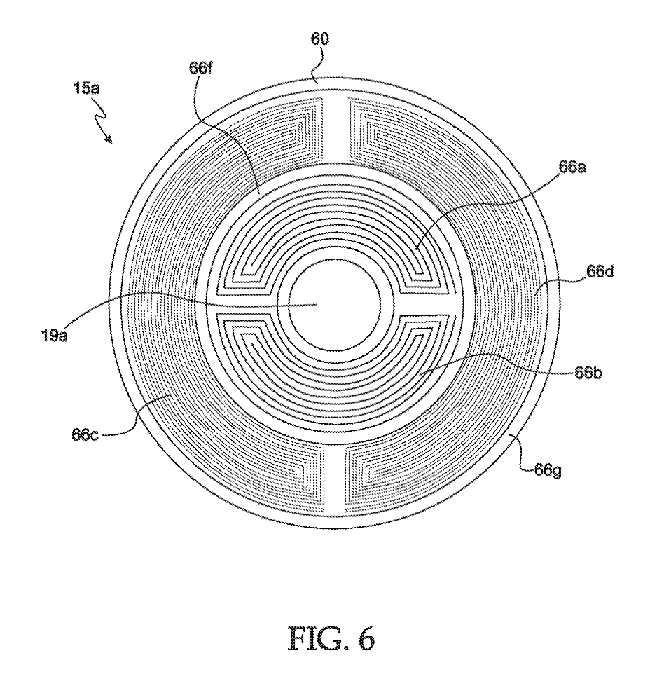

FIG. 6 shows further details according to one embodiment of sensing element 15a of FIGS. 4 and 5. Emitter and receiver coils 66a through 66g are configured as interleaved electrically conductive traces disposed on an underlying surface, which in turn is attached to or forms a portion of substrate 60. As shown in FIG. 6, each of the inductive sine and cosine coils is operably located above and aligned in respect of corresponding encoder device 14a. The electrically conductive portion of encoder device 14a is responsive to signals transmitted by the inductive coil emitters, which in turn essentially reflect such transmitted signals back to differentially paired receiver coils, respectively, as flexible spline 12a rotates with respect to sensing element 15a. That is, the rotation of flexible spline 12a causes the electrically conductive portion 14a thereof to be sensed by the receiver coils corresponding thereto. Each pair of receiver coils outputs one cycle of SIN & COS signals for each complete revolution of flexible spline 12a. In the embodiments shown in FIGS. 1 through 6, the position logic device or processor then interpolates such signals into a 6 bit count.

Note that the inductive coils employed in multi-turn encoder 10 described herein are different from those typically employed in single-turn encoders. For example, the multi-turn inductive coils disclosed herein comprise discrete and separate emitter and receiver sectors, while single-turn inductive coils of the prior art are generally rectangular in shape. The multi-turn inductive coils disclosed herein comprise a set of receiver coils capable of “seeing” an entire revolution of a geared circular disk, while single-turn inductive coils of the prior art contain redundant coils capable of “seeing” only a portion of the revolution of a disk. While the multi-turn inductive coils disclosed herein provide only one sinusoidal signal for each revolution of a disk, single-turn inductive coils of the prior art generally yield several sinusoidal signal for each revolution of a disk.

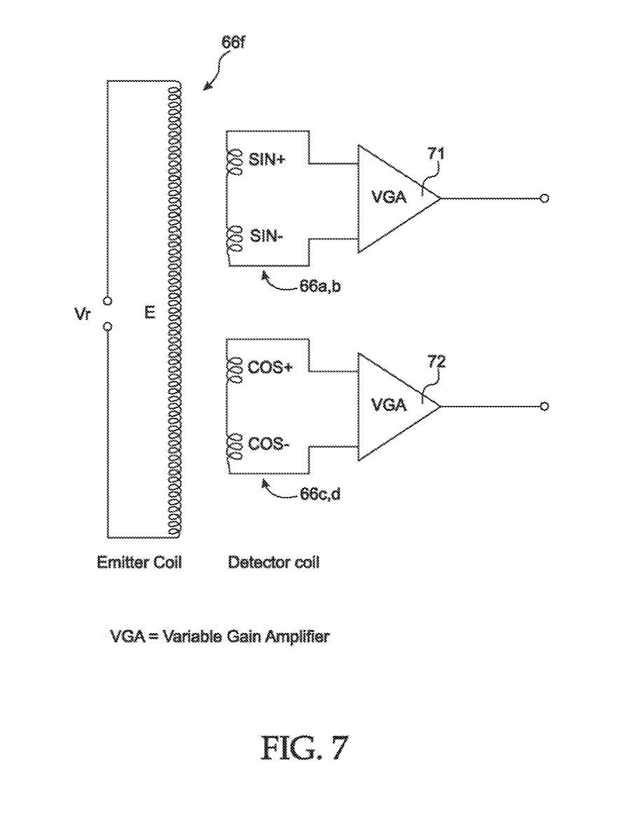

FIG. 7 shows a representative schematic electrical diagram of one inductive coil comprising an emitter coil 66f and two pairs of receiver coils 66a,b and 66c,d, which are each operably connected to a corresponding variable gain amplifier 71 or 72, which are each configured to receive and amplify the output signals provided thereto by the emitter coils.

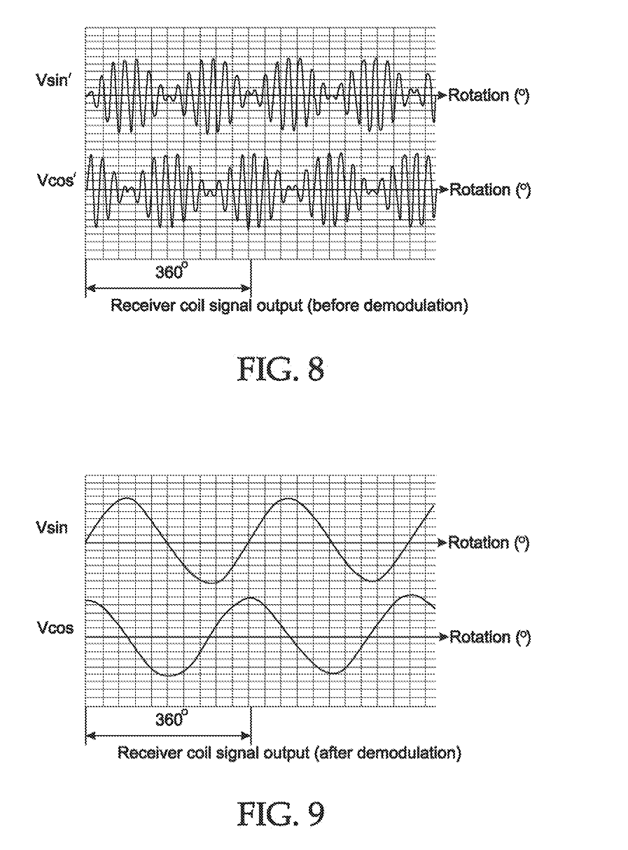

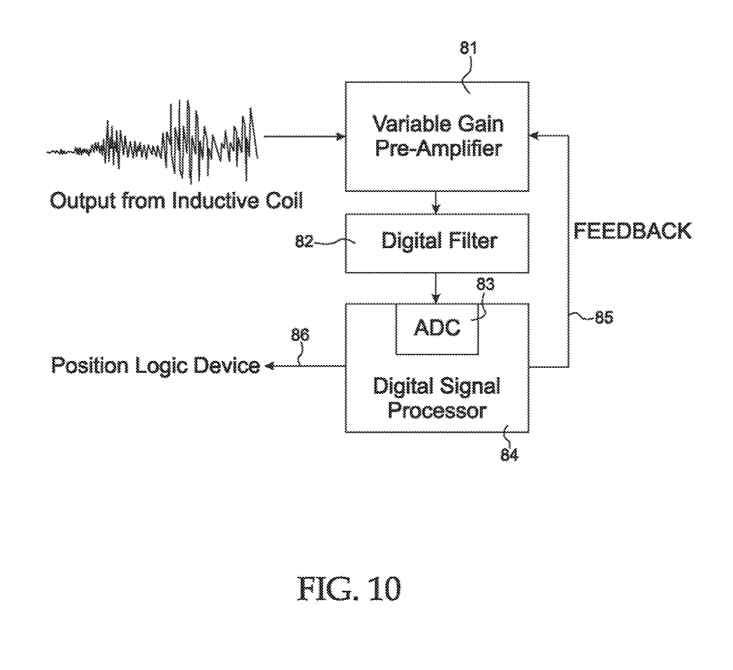

Representative waveforms provided as outputs by receiver coils 90 degrees out of phase with respect to one another are shown in FIG. 8 (before demodulation) and FIG. 9 (after demodulation). A carrier frequency signal included in the output signals provided by the emitter coils may be removed by a suitable digital filtering circuit, as is known in the art. As further illustrated in FIG. 10, an analog-to-digital converter configured to convert the output signals provided by the emitter coils into a digital format may also be employed as part of the position logic device to provide a digital output signal representative of a shaft position and/or the number of revolutions the shaft has rotated.

As will now become apparent, the multi-turn inductive encoder disclosed herein has numerous advantages, especially in regards to providing a multi-turn encoder of small volume and small size that is capable of providing a very high number of bits or rotational counting resolution, and in regards to providing an encoder which permits the rotational position of a disk to be monitored and measured throughout its entire revolution without using an excessive number of coils, tracks or traces. These features, in turn, permit a multi-turn encoder to be provided which has increased flexibility respecting the applications in which it may be employed in comparison to optical encoders.

Various embodiments of the multi-turn inductive encoder of the invention may also be configured to generate direct raw output signals conforming to virtually any desired format such as Gray code, binary and so on, which optical multi-turn encoders are incapable of providing. The multi-turn inductive encoders of the invention are also capable of withstanding very high operating temperatures, and are especially resistant to dust, liquid and other environmental contaminants.

Various embodiments of the sensing elements and encoder devices of the harmonic gear multi-turn encoder disclosed herein may be configured to operate in conjunction with optical light sources and sensors (e.g., reflective systems), Hall Effect sensors and encoders, electric sensors and encoders, magnetic sensors and encoders, and so on, and are not limited to inductive embodiments alone. The inductive sensing elements of some embodiments may also be fabricated directly on a flexible circuit, a printed circuit board, a ceramic substrate, or any other suitable substrate material.

Reference to Table 1 and other portions of the present specification and drawings shows that a virtually endless number of permutations, combinations and/or modifications may be made to the various embodiments of the harmonic gear multi-turn encoders disclosed herein without departing from the spirit and scope of the invention.

Note that included within the scope of the present invention are methods of making and having made the various components, devices and systems described herein.

For example, according to one embodiment there is provided a method of determining a number of revolutions a shaft in a multi-turn encoder has turned comprising providing a first stage of the encoder comprising a first rotatable wave generator comprising a first input shaft, a first flexible spline operably coupled to at least a portion of the first wave generator, the first flexible spline having a first number of geared teeth disposed about a first outer periphery thereof, a first encoding device attached to the first flexible spline, a first circular spline configured to receive and engage at least a portion of the first outer periphery of the first flexible spline in a first inner periphery thereof, the first circular spline having a second number of geared teeth disposed about the first inner periphery, the first number of teeth being less than the second number of teeth, and a first sensing element configured to sense rotation of the first encoding device in respect thereof, wherein a first gearing reduction ratio of the first stage equals (the first number of teeth−the second number of teeth)/(the first number of teeth), rotating the first shaft of the first wave generator and thereby causing the first flexible spline and the first circular spline to rotate with respect to one another according to the first gear reduction ratio, and generating, with the first sensing element, an output signal representative of a revolution of the first flexible spline and the first encoding device corresponding thereto thereby to permit a number of revolutions the shaft has rotated to be determined by a position logic device.

Such a method may further comprise providing a second stage operably coupled to the first stage, the second stage comprising a second rotatable wave generator comprising a second input shaft operably coupled to the first bearing station, a second flexible spline operably coupled to at least a portion of the second wave generator, the second flexible spline having a third number of geared teeth disposed about a second outer periphery thereof, a second encoding device attached to the second flexible spline, a second circular spline configured to receive and engage at least a portion of the second outer periphery of the second flexible spline in a second inner periphery thereof, the second circular spline having a fourth number of geared teeth disposed about the second inner periphery, the third number of teeth being less than the fourth number of teeth, and a second sensing element configured to sense rotation of the second encoding device in respect thereof, wherein a second gearing reduction ratio of the second stage equals (the third number of teeth−the fourth number of teeth)/(the third number of teeth), rotating the second shaft of the second wave generator through the action of the first shaft and the first wave generator and thereby causing the second flexible spline and the second circular spline to rotate with respect to one another according to the second gear reduction ratio, and generating, with the second sensing element, an output signal representative of a revolution of the second flexible spline and the second encoding device corresponding thereto thereby to permit a number of revolutions the second shaft has rotated to be determined by a position logic device.

The above-described embodiments should be considered as examples of the present invention, rather than as limiting the scope of the invention. In addition to the foregoing embodiments of the invention, review of the detailed description and accompanying drawings will show that there are other embodiments of the invention. Accordingly, many combinations, permutations, variations and modifications of the foregoing embodiments of the invention not set forth explicitly herein will nevertheless fall within the scope of the invention.

We claim:

1. A multi-turn encoder module having a first stage comprising:
a first rotatable wave generator comprising a first input shaft;
a first flexible spline operably coupled to at least a portion of the first wave generator, the first flexible spline having a first number of geared teeth disposed about a first outer periphery thereof;
a first encoding device attached to the first flexible spline;
a first circular spline configured to receive and engage at least a portion of the first outer periphery of the first flexible spline in a first inner periphery thereof, the first circular spline having a second number of geared teeth disposed about the first inner periphery, the first number of teeth being less than the second number of teeth;
and a first sensing element comprising at least one sensor configured to sense rotation of the first encoding device in respect thereof;
wherein a first gearing reduction ratio of the first stage equals:
(the first number of teeth−the second number of teeth)/(the first number of teeth).

2. The multi-turn encoder module of claim 1, wherein the first sensing element further comprises a substrate upon which the first plurality of inductive coils are disposed.

3. The multi-turn encoder module of claim 1, wherein the first encoding device comprises a half-disk formed of electrically conductive material.

4. The multi-turn encoder module of claim 1, wherein the first rotatable wave generator further comprises at least one cam configured to engage a first inner periphery of the first flexible spline.

5. The multi-turn encoder module of claim 1, wherein the gear reduction ratio of the first stage is greater than or equal to 4.

6. The multi-turn encoder module of claim 1, wherein the gear reduction ratio of the first stage is greater than or equal to 2 bits.

7. The multi-turn encoder module of claim 1, wherein the first number of teeth differs from the second number of teeth by one or two teeth.

8. The multi-turn encoder module of claim 1, wherein the first sensing element comprises a first plurality of inductive coils.

9. The multi-turn encoder module of claim 8, wherein each of the first plurality of inductive coils is integrated into the first substrate.

10. The multi-turn encoder module of claim 8, wherein each of the first plurality of inductive coils forms a separate component attached to the first substrate.

11. The multi-turn encoder module of claim 8, wherein each of the first plurality of inductive coils comprises at least one emitter coil and at least one receiver coil.

12. The multi-turn encoder module of claim 11, wherein the at least one receiver coil comprises at least one pair of receiver coils.

13. The multi-turn encoder module of claim 12, wherein the receiver coils are arranged 90 degrees out of phase with respect to one another.

14. The multi-turn encoder module of claim 1, further comprising a variable gain pre-amplifier configured to receive and amplify output signals provided by the first sensing element.

15. The multi-turn encoder module of claim 14, further comprising a digital filtering circuit configured to remove a carrier frequency of the output signals.

16. The multi-turn encoder module of claim 14, further comprising an analog-to-digital converter configured to convert the output signals from an analog form to a digital representation thereof.

17. The multi-turn encoder module of claim 14, further comprising a digital signal processor configured to provide a digital output signal representative of a position of the first input shaft.

18. The multi-turn encoder module of claim 14, further comprising a digital signal processor configured to provide a digital output signal representative of the number of revolutions the first input shaft has rotated.

19. The multi-turn encoder module of claim 1, wherein the encoder module is mounted on or attached to one of a flexible circuit, a printed circuit board, and a ceramic substrate.

20. The multi-turn encoder module of claim 1, further comprising a first bearing station coupled to the first sensing element.

21. The multi-turn encoder module of claim 20, wherein the first flexible spine is rotatable with respect to the first bearing station.

22. The multi-turn encoder module of claim 21, wherein the first bearing station is stationary with respect to the first flexible spine.

23. The multi-turn encoder module of claim 20, further comprising a second stage operably coupled to the first stage, the second stage comprising a second rotatable wave generator comprising a second input shaft operably coupled to the first bearing station, a second flexible spline operably coupled to at least a portion of the second wave generator, the second flexible spline having a third number of geared teeth disposed about a second outer periphery thereof, a second encoding device attached to the second flexible spline, a second circular spline configured to receive and engage at least a portion of the second outer periphery of the second flexible spline in a second inner periphery thereof, the second circular spline having a fourth number of geared teeth disposed about the second inner periphery, the third number of teeth being less than the fourth number of teeth, and a second sensing element configured to sense rotation of the second encoding device in, respect thereof, wherein a second gearing reduction ratio of the second stage equals (the third number of teeth−the fourth number of teeth)/(the third number of teeth).

24. The multi-turn encoder module of claim 23, wherein the gear reduction ratio of the second stage is greater than or equal to 4.

25. The multi-turn encoder module of claim 23, wherein the gear reduction ratio of the second stage is greater than or equal to 2 bits.

26. The multi-turn encoder module of claim 23, wherein the third number of teeth differs from the fourth number of teeth by one or two teeth.

27. The multi-turn encoder module of claim 23, further comprising a second bearing station that is stationary with respect to the second flexible spine.

28. The multi-turn encoder module of claim 23, wherein the second flexible spline is rotatable with respect to the second bearing station.

29. A method of determining a number of revolutions a shaft in a multi-turn encoder has turned, comprising:
providing a first stage of the encoder comprising a first rotatable wave generator comprising a first input shaft, a first flexible spline operably coupled to at least a portion of the first wave generator, the first flexible spline having a first number of geared teeth disposed about a first outer periphery thereof, a first encoding device attached to the first flexible spline, a first circular spline configured to receive and engage at least a portion of the first outer periphery of the first flexible spline in a first inner periphery thereof, the first circular spline having a second number of geared teeth disposed about the first inner periphery, the first number of teeth being less than the second number of teeth, and a first sensing element configured to sense rotation of the first encoding device in respect thereof, wherein a first gearing reduction ratio of the first stage equals (the first number of teeth−the second number of teeth)/(the first number of teeth),
rotating the first shaft of the first wave generator and thereby causing the first flexible spline and the first circular spline to rotate with respect to one another according to the first gear reduction ratio, and
generating, with the first sensing element, an output signal representative of a revolution of the first flexible spline and the first encoding device corresponding thereto thereby to permit a number of revolutions the shaft has rotated to be determined by a position logic device.

30. The method of claim 29, further comprising providing a second stage operably coupled to the first stage, the second stage comprising a second rotatable wave generator comprising a second input shaft operably coupled to the first bearing station, a second flexible spline operably coupled to at least a portion of the second wave generator, the second flexible spline having a third number of geared teeth disposed about a second outer periphery thereof, a second encoding device attached to the second flexible spline, a second circular spline configured to receive and engage at least a portion of the second outer periphery of the second flexible spline in a second inner periphery thereof, the second circular spline having a fourth number of geared teeth disposed about the second inner periphery, the third number of teeth being less than the fourth number of teeth, and a second sensing element configured to sense rotation of the second encoding device in respect thereof, wherein a second gearing reduction ratio of the second stage equals (the third number of teeth−the fourth number of teeth)/(the third number of teeth);
rotating the second shaft of the second wave generator through the action of the first shaft and the first wave generator and thereby causing the second flexible spline and the second circular spline to rotate with respect to one another according to the second gear reduction ratio, and
generating, with the second sensing element, an output signal representative of a revolution of the second flexible spline and the second encoding device corresponding thereto thereby to permit a number of revolutions the second shaft has rotated to be determined by a position logic device.
